(19) United States
(12) Patent Application Publication
(10) Pub. No.: US 2023/0311289 A1
(43) Pub. Date: Oct. 5, 2023

(54) HAND-HELD POWER TOOL, TOOL AND HAND-HELD POWER TOOL SYSTEM WITH A DETERMINED SPEED/IMPACT POWER RATIO

(71) Applicant: Hilti Aktiengesellschaft, Schaan (LI)

(72) Inventors: Maximilian KNYRIM, Ehingen (DE); Markus HARTMANN, Mauerstetten (DE); Bastian PLÜMACHER, Landsberg am Lech (DE); Olaf KOCH, Kaufering (DE)

(21) Appl. No.: 18/014,100

(22) PCT Filed: Feb. 22, 2021
(86) PCT No.: PCT/EP2021/054287

§ 371 Date: Dec. 30, 2022

(30) Foreign Application Priority Data
Jul. 17, 2020 (EP) 20186380.0

(51) Int. Cl. B25D 16/00; B25D 11/06; B25D 17/02; B23B 51/00

(52) U.S. Cl. CPC B25D 16/00; B25D 11/06; B25D 17/02; B25D 2217/0003; B25D 2216/003; B25D 2250/201; B23B 51/00

(57) ABSTRACT

A hammer drill having an impact mechanism and a rotary drive, wherein the hammer drill is designed to rotate a tool at a speed n about a longitudinal axis of the tool and to drive it with an output impact power PS along the longitudinal axis with a striking movement is disclosed. At a working point, at least one condition is met: 1. The ratio of the output impact power PS to the speed n is at least 3.5 W/rpm; 2. Depending on the output impact power PS, the speed n is at most (PSAN−300)2/2000+150) rpm; 3. In the event of an infinitesimal change in the output impact power PS, the speed n changes by at most 0.1 rpm/W.

The present invention relates to a hand-held power tool, in particular hammer drill, with an impact mechanism and a rotary drive, wherein the hand-held power tool is configured to rotate a tool at a rotational speed n about a longitudinal axis of the tool and to drive said tool with an impact movement along the longitudinal axis with an output impact power PS, and wherein the hand-held power tool is portable. The invention furthermore relates to a tool and to a hand-held power tool system.

The contents of the descriptions, the claims and the drawings of European applications EP19192219A of Aug. 19, 2019, EP19193854 of Aug. 27, 2019 and EP19195363A of Sep. 4, 2019 form part of this description by way of express reference.

For ecological reasons as well as for cost reasons, there is a particular need for particularly effectively and efficiently working hand-held power tools, for example hammer drills, associated tools and, in particular, a hand-held power tool and a tool for hand-held tool systems having the hand-held power tool. This is all the more true for the portable hand-held power tools of the generic type, since higher efficiency is often associated with the possibility of using lighter drive units and thus with possible weight reductions of the hand-held power tools.

In order to meet this need, it is therefore an object of the present invention to provide hand-held power tools, tools and hand-held power tool systems of the generic type that can be operated with particularly high efficiency.

This object is achieved by a hand-held power tool, in particular a hammer drill, with an impact mechanism and a rotary drive, wherein the hand-held power tool is configured to rotate a tool at a rotational speed n about a longitudinal axis of the tool and to drive said tool with an impact movement along the longitudinal axis with an output impact power PS, and wherein the hand-held power tool is portable, wherein at least one of the following conditions is met at least at one working point of the hand-held power tool
1. the ratio of the output impact power PS to the rotational speed n is at least 3.5 W/rpm;
2. the rotational speed n is at most ((PS/W−300)\hat{ }2/2000+150) rpm depending on the output impact power PS;
3. in the event of an infinitesimal changes in the output impact power PS, the rotational speed n changes by at most 0.1 rpm/W.

Accordingly, hand-held power tools that each meet one of the three conditions can each form a subgroup of hand-held power tools according to the invention.

It is conceivable for a hand-held power tool to meet precisely two of the three conditions, in particular the conditions 1 and 2, 1 and 3 or 2 and 3. Alternatively and particularly preferably, it can also meet all three conditions.

The invention is based on the concept of being able to crush such rocks, for example in order to form a borehole, customarily primarily by means of the impact movement. In particular, the crushing can be undertaken by means of a tool tip of a tool held in the tool fitting, for example a rock drill, in the form of rhythmic impact, that is to say chiseling.

During the crushing, the parallel rotational movement usually has the purpose of rotating and/or displacing the tool tip such that the crushing can take place over a certain processing area, i.e. not just at a single point. In addition, the rotational movement—at least in the case of tools with a helical structure formed along their longitudinal axis, such as, for example, in the case of rock twist drills—is required for conveying cuttings produced at the tool tip.

However, with increasing rotational speeds n there are considerable, sometimes disproportionately increasing, friction losses.

Considerable energy savings can thus be achieved if the hand-held power tool, as provided according to the invention, executes a rotational movement that is comparatively slow in relation to the output impact power PS, at least at the working point. However, the rotational movement at the working point is preferably nevertheless so fast that a sufficient rotary offset of the tool can take place between two impacts. Depending on the type of tool used, the rotational speed can also be selected depending on a required cuttings conveying speed, in particular if there is a structurally determined relationship between them. According to the invention, the abovementioned conditions 1 and 2 mean that this ratio is directly limited at least for the working point.

Condition 3 also defines, at least implicitly, a limit for the ratio at the working point, in particular via a gradient at the working point. Experience has shown that, in particular in the case of hand-held power tools with a drive unit, there is a fixed relationship between the change in the rotational speed n in the event of infinitesimal changes in the output impact power PS, on the one hand, and the output impact power PS, on the other hand. This relationship can, for example, follow a curve to the third power or a corresponding square root function, such that, in association therewith, maximum rotational speeds n outside the working point, for example at a regulated rotational speed in a hand-held power tool with a drive unit, can also be provided at the same time on the device side. Thus, according to the invention, hand-held power tools can also be provided which work particularly efficiently not only at the working point, but, for example, even in partial load operation.

An “infinitesimal change” of a measured variable, such as, for example, the output impact power PS, can mean a change that is as small as possible according to the respective technical circumstances and possibilities, for example of less than at most 1 percent, preferably of at most one per thousand, of the output value of the measured variable.

In the case of particularly efficient hand-held power tools, at least at the working point, in the event of infinitesimal changes in the output impact power PS, the rotational speed n can change by at most 0.08 rpm/W and particularly preferably by at most 0.08 rpm/W.

Furthermore, tool damage and/or damage to the rock being processed due to overheating because of friction and heat can be avoided by the invention. Work safety can also be increased.

The working point can correspond to a hammer drill operation of the hand-held power tool. In particular, it can correspond to a full load operation of the hand-held power tool. As an alternative or in addition, the working point can correspond to an operating state with a device-related highest possible output impact power PS or a highest possible rotational frequency n.

The hand-held power tool can be configured in particular for processing natural or artificial rocks, for example masonry and/or cement-containing rocks.

For delimitation in relation to, for example, pure chiseling machines, the rotational speed at the working point can be at least 1 rpm, preferably at least 20 rpm.

As an alternative or in addition, an indexing angle, i.e. the angle by which the tool is offset between two impacts, can be at least 15, preferably at least 20 degrees, at least at the working point.

As an alternative or in addition, the rotational speed n can be at least half of the maximum value according to at least one of the three conditions, depending on the output impact power PS.

The output impact power PS can depend in particular on an individual impact energy, i.e. the amount of energy output in a single impact, and the impact frequency fat which impacts are carried out.

The invention is thus furthermore based on the finding that hand-held power tools permitting a combination of an impact movement with a rotational movement at least at the working point can be improved by selecting and/or setting the ratio between the rotational speed n and the output impact power PS at least at said working point.

A particularly easily portable hand-held power tool can have at most one drive unit, in particular a motor, by means of which the impact mechanism and the rotary drive can be jointly driven.

In general, the hand-held power tool can have at most one drive unit, in particular a motor, for driving the impact mechanism and the rotary drive. In other words, the impact mechanism and the rotary drive can be driven by means of a common drive unit. Alternatively, a separate drive, in particular by means of at least two drive units, is also conceivable. The rotational speed n and/or the output impact power PS or the ratio thereof with respect to each other can be defined or definable in a device-related manner. For example, at the working point, one or more transmissions of the hand-held power tool can be selected by the hand-held power tool automatically during use and/or. The transmission or the transmissions can have transmission ratios tailored to the working point.

In the case of hand-held power tools having at least two drive units, by means of which in particular the rotational speed n is set or can be set at least within a range independently of the output impact power PS, provision can be made to limit the rotational speed n to at most 1400 rpm, preferably to at most 700 rpm.

The output impact power PS can be between 200 W and 2000 W, preferably between 200 W and 1000 W, at least at the working point.

Particularly preferably, the output impact power PS can be at least 300 W at the working point.

It is conceivable to provide a constant maximum possible rotational speed n, for example 150 rpm, in a low range of the output impact power PS, for example at less than 500 W or alternatively at less than 300 W.

The impact mechanism can be in the form of an electric, for example electropneumatic, impact mechanism.

For reasons of the range of adjustability of the hand-held power tool, it is advantageous if the hand-held power tool has a multi-stage transmission.

The hand-held power tool can be configured to control a transmission on the basis of, or at least taking into consideration, the determined or set type of received tool, in particular to select one of the transmission stages of a multi-stage transmission in dependence thereon. As an alternative or in addition, in the case of hand-held power tools having at least two drive units, a ratio of the speeds of the two drive units to one another can also be set or settable, in particular in dependence on the set or determined type of received tool.

In the case of a hand-held power tool having different operating modes, for example a pure rotational movement mode or drilling mode and a hammer drill mode corresponding to the working point, it is conceivable to configure the hand-held power tool in such a way that, by changing into the hammer drill mode or on reaching the working point, the rotational speed n is limited a maximum value according to at least one of the three conditions and, on leaving the hammer drill mode or the working point, this limitation is lifted and/or the maximum value of the rotational speed n is set to a higher value.

The hand-held power tool can have a tool recognition device for identifying a type of tool used in the tool fitting. As an alternative or in addition, the type of tool used in the tool fitting can also be settable by a user of the hand-held power tool.

The hand-held power tool can also be configured, depending on the type of tool, preferably at least at the working point, to limit the rotational speed n to a maximum value that satisfies at least one of the three conditions. For example, in the case of a tool in the form of a suction drill or a hollow drill, a particularly low maximum value of the rotational speed n can be set, whereas in the case of a tool having a helical structure, a somewhat higher maximum value, but preferably nevertheless at most corresponding at least to one of the three conditions according to the invention, is set.

The hand-held power tool can be configured in particular to vary the value of the rotational speed n depending on the output impact power PS, in particular also taking into account a type of tool used. This is based on the concept that, at very low output impact powers PS, for example, a minimum rotational speed n can be ensured by this variation. At least in the case of individual types of tool, the increase in friction due to the rotational movement can be less than a third power, and therefore relatively higher rotational speeds n can also be used relative to the output impact power PS.

If the overall available power of the hand-held power tool is limited, this also makes it possible to direct a larger proportion of the overall power to the impact movement such that the propulsion achieved in the rock can be increased with the same overall power. As an alternative or in addition, the overall power used can also be reduced while maintaining the propulsion achieved.

An electric impact mechanism can be understood to be electromechanically operating impact mechanisms, in particular with a rotation-generating drive, for example cam impact mechanisms or ratchet impact mechanisms, electropneumatic impact mechanisms, that is to say impact mechanisms containing an air chamber for the transmission and/or transformation of the impact movement, as well as electromagnetic impact mechanisms, for example based on the principle of a railgun and/or impact mechanisms having a linear motor. The impact mechanism can be a direct impact mechanism, that is to say with a drive that is free of rotational movement, or an indirect impact mechanism, that is to say with a drive based on a rotational movement.

If the hand-held power tool has a pneumatic, in particular an electropneumatic, cuttings conveying device, particularly low rotational speeds n can be used, since cuttings can be conveyed by the cuttings conveying device. The cuttings conveying device can be or can have a suction device.

A portable hand-held power tool can be understood to mean a hand-held power tool with a weight of at most 25 kg. Alternatively or in addition, a portable hand-held power tool can be understood to mean a hand-held power tool, the output impact power PS of which is limited to at most 2 kW, particularly preferably to at most 1 kW.

The hand-held power tool can particularly preferably be operated wirelessly. It can have a battery, in particular a lithium-containing battery. The hand-held power tool can, for example, have a portable power storage device, for example a rechargeable battery. The increases in effectiveness and efficiency achieved according to the invention make it possible to achieve particularly long running times with a single battery charge.

According to the invention, the transmission or the transmissions can have particularly high reduction ratios, for example 50:1. Hand-held power tools are therefore particularly preferred which comprise at least one overrunning clutch, a gate-type transmission or a circular thrust transmission. For example, combinations of the overrunning clutch with the gate-type transmission and/or the circular thrust transmission are also conceivable. Further details according to the invention relating to particularly advantageous refinements of the overrunning clutch, the gate-type transmission and the circular thrust transmission are found in the European patent applications mentioned at the beginning and incorporated by reference as part of this description.

In the case of a tool having a helical structure for a hand-held power tool according to the invention, the gradient of the helical structure can be increased compared to known helical structures, in particular of tools for processing rocks.

The scope of the invention also includes a tool for a hand-held power tool according to the invention, comprising a tool tip, a tool shaft and a shank for holding the tool in the tool fitting of the hand-held power tool, wherein a material transport channel is formed at least along the tool shaft, wherein the material transport channel has a minimum cross-sectional area of 19 mm² or at least 6%, particularly preferably at least 12%, of the cross-sectional area of the borehole which can be produced by the tool. In particular when working at comparatively low rotational speeds n, larger cuttings particles can increasingly arise, which can also be safely transported away owing to the comparatively large material transport channel. Clogging of the tool can thus be avoided even at rotational speeds n which are low in relation to the impact frequency f.

In general, the tool can be in the form of a hollow drill.

Such a tool enables particularly powerful drilling cuttings to be conveyed either through the material transport channel or by a flushing fluid, which is preferably conveyed to the tool tip via the material transport channel, so that cuttings can be flushed away from the tool tip for removal.

In general, the tool and/or the hand-held power tool can be configured to convey the cuttings mechanically, pneumatically or hydraulically.

In particular, the tool can be in the form of a suction drill for this purpose. The drilling conveyor device can have a suction device, in particular adapted to the tool.

The scope of the invention also includes use of a tool according to the invention for working natural or artificial rock.

The object is also achieved by a hand-held power tool system comprising a hand-held power tool according to the invention and a tool according to the invention.

The hand-held power tool system can be configured for processing natural or artificial rocks.

Further features and advantages of the invention emerge from the following detailed description of exemplary embodiments of the invention, with reference to the figures of the drawing, which shows details essential to the invention, from the claims and from the description and the figures of the drawing, which also shows details essential to the invention, by reference to incorporated European patent applications mentioned at the beginning. The features shown there are not necessarily to be understood as true to scale and are shown in such a way that the special features according to the invention can be made clearly visible. The various features can be implemented individually or collectively in any combinations in variants of the invention.

In the schematic drawing, exemplary embodiments of the invention are shown and explained in more detail in the following description.

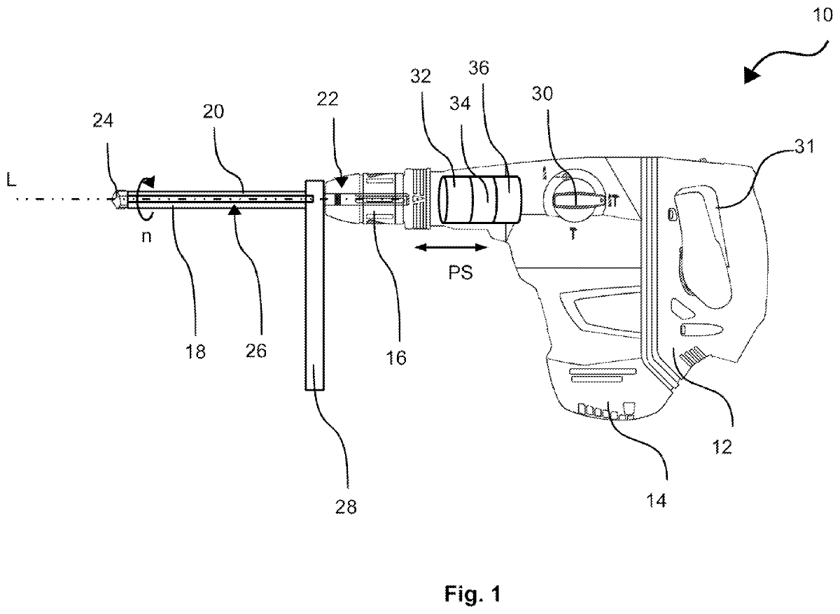

The only FIGURE (FIG. 1) shows a hand-held power tool system.

A hand-held power tool system 10 has a hand-held power tool 12. The hand-held power tool 12 can be operated wirelessly. For this purpose, it has a rechargeable battery 14. It is in the form of a portable device. It preferably has a weight of between 5 and 15 kg and generally of less than 25 kg.

It also has a tool fitting 16.

A tool 18 is held in the tool fitting. For this purpose, the tool 18 has a tool shaft 20, at one end of which a shank 22 is formed and at the other end of which a tool tip 24 is formed.

The tool 18 is in the form of a hollow drill and in particular a suction drill. For this purpose, it has a material transport channel 26, which runs inside the tool shaft 20 and is shown schematically in FIG. 1, via which cuttings extracted from the vicinity of the tool tip 24 can be conveyed to a cuttings conveying device 28.

The material transport channel 26 has a cross-sectional area of 15% of the cross section of a borehole to be created by the tool 18.

Furthermore, the hand-held power tool 12 has an operating mode selector switch 30 for switching between different operating modes, in particular for switching between a pure drilling mode, a pure chiseling mode and a hammer drill mode. In the position shown of the operating mode selector switch 30, the hammer drill mode is selected.

The hand-held power tool 12 also has an electropneumatic impact mechanism 32 and a rotary drive 34. The impact mechanism 32 and the rotary drive 34 are driven by a common drive unit 36, an electric motor. The hand-held power tool 12 is configured to rotate the tool 18 held in the tool fitting 16 at a rotational speed n about a longitudinal axis L of the tool 18 and to drive said tool along the longitudinal axis L with an impact movement such that an impact power PS is output.

The hand-held power tool 12 has at least one transmission. The transmission can, for example, have an overrunning clutch, a gate-type transmission or a circular thrust transmission in accordance with the European patent applications mentioned at the beginning and incorporated by reference.

The hand-held power tool 12 can be set in motion by means of an actuating lever 31 and, in particular, operated at a working point with a device-related highest possible output impact power PS.

In this exemplary embodiment, the ratio of the output impact power PS to the rotational speed n at the working point is 4 W/rpm, in particular with an output impact power PS of 0.5 kW and a rotational speed n of 125 rpm.

Further exemplary embodiments which, unless expressly stated otherwise, correspond to this preceding exemplary embodiment are described below.

In the case of an exemplary embodiment of the hand-held power tool 12 that is especially tailored to the use of a tool 18 in the form of a hollow drill, the output impact power PS is also 0.5 kW at a rotational speed of 5*10¹ rpm.

This hand-held power tool 12 is configured to generate a single impact energy of 10¹ joules at an impact frequency f of 5*10¹ Hz at the working point. This hand-held power tool 12 has a tool recognition device or, according to a particular embodiment, alternatively a tool selector switch with which a user of the hand-held power tool 12 can set a type of tool. The hand-held power tool 12 is then configured, when a hollow drill is recognized or set as the type of tool, to lower the rotational speed to a maximum of 5*10¹ rpm, for example, and to increase same in the case of other types of tools, for example rock drills with a helical structure. For this purpose, in contrast to the previous exemplary embodiment, the hand-held power tool 12 has two drive units 36 for separately driving the impact mechanism 32 and the rotary drive 32. As a result, the hand-held power tool 12 is also capable of keeping the rotational speed n of 5*10¹ rpm, which is mentioned by way of example in the case of a hollow drill as the tool 18, constant,—or of keeping another low rotational speed n, corresponding to at least one of the three conditions, constant, independently of the output impact power PS.

In a further, modified embodiment, preferably again with only one common drive unit 36, the hand-held power tool 12 has a multi-stage transmission. The hand-held power tool 12 is configured to switch the transmission depending on the recognized or set type of tool. In particular, in the case of a hollow drill, a particularly greatly reduced shifting step of the transmission is engaged.

This transmission too can, for example, have an overrunning clutch, a gate-type transmission or a circular thrust transmission in accordance with the European patent applications mentioned at the beginning and incorporated by reference.

The hand-held power tools 12 according to these aforementioned exemplary embodiments are thus configured to meet the 1st condition, by means of which a rotational speed n of at most approx. 170 rpm can be achieved at the working point with 0.5 kW.

They are also configured to meet the 2nd condition, by means of which a rotational speed n of at most approx. 143 rpm can be achieved at the working point with 0.5 kW.

In a further exemplary embodiment of a hand-held power tool 12, the output impact power PS at the working point is 0.45 kW at a rotational speed n of approximately 7*10¹ rpm. The gradient at the working point, i.e. with an output impact power of 0.45 kW, is 0.05 rpm/W, i.e. with an infinitesimal changes in the output impact power PS, the rotational speed n changes by 0.05 rpm/W. This hand-held power tool 12 thus simultaneously corresponds to conditions 1, 2 and 3. It also has a particularly high level of efficiency in partial load operation, i.e. at output impact powers PS of below 0.45 kW.

5. The hand-held power tool as claimed in claim 1, wherein the hand-held power tool has a multi-stage transmission.

6. The hand-held power tool as claimed in claim 1, wherein the hand-held power tool has a tool recognition device for identifying a type of tool used in a tool fitting of the hand-held power tool, and/or in that the hand-held power tool is configured such that the type of tool used in the tool fitting can be set by a user of the hand-held power tool.

7. The hand-held power tool as claimed in claim 1, having a pneumatic cuttings conveying device.

8. The hand-held power tool as claimed in claim 1, wherein the hand-held power tool can be operated wirelessly.

9. The hand-held power tool as claimed in claim 1 comprising at least one overrunning clutch, a gate-type transmission or a circular thrust transmission.

10. A tool for a hand-held power tool as claimed in claim 1, comprising a tool tip, a tool shaft and a shank for holding the tool in a tool fitting of the hand-held power tool, wherein a material transport channel is formed at least along the tool shaft, wherein the material transport channel has a minimum cross-sectional area of 19 mm² or at least 6% of a cross-sectional area of a borehole which can be produced by the tool.

11. The tool as claimed claim 10, wherein the tool is in the form of a suction drill.

12. A hand-held power tool system, comprising a hand-held power tool comprising an impact mechanism and a rotary drive, wherein the hand-held power tool is configured to rotate a tool at a rotational speed n about a longitudinal axis of the tool and to drive the hand-held power tool with an impact movement along the longitudinal axis with an output impact power PS, and wherein the hand-held power tool is portable, wherein at least one of the following conditions is met at a working point of the hand-held power tool:
1. a ratio of the output impact power PS to the rotational speed n is at least 3.5 W/rpm;
2. the rotational speed n is at most ((PS/W−300)\hat{ }2/2000+150) rpm depending on the output impact power PS;
3. in an event of an infinitesimal change in the output impact power PS, the rotational speed n changes by at most 0.1 rpm/W, and
a tool comprising a tool tip, a tool shaft and a shank for holding the tool in a tool fitting of the hand-held power tool, wherein a material transport channel is formed at least along the tool shaft, wherein the material transport channel has a minimum cross-sectional area of 19 mm² or at least 6% of a cross-sectional area of a borehole which can be produced by the tool.

13. The hand-held power tool of claim 2, wherein the at least one drive unit is a motor.

14. The hand-held power tool of claim 3, wherein the output impact power PS is between 200 W and 1000 W, at least at the working point.

15. The hand-held power tool of claim 4, wherein the impact mechanism is an electropneumatic impact mechanism.

16. The hand-held power tool of claim 7, having an electropneumatic cuttings conveying device.

17. The hand-held power tool of claim 8, having a battery.

18. The hand-held power tool of claim 17, having a lithium-containing battery.

19. The tool of claim 10, wherein the material transport channel has a minimum cross-section area of at least 12% of the cross-section area of the borehole which can be produced by the tool.

20. The hand-held power tool as claimed in claim 2, wherein the output impact power PS is between 200 W and 2000 W at least at the working point.
